(19) United States
(12) Patent Application Publication
(10) Pub. No.: US 2006/0061662 A1
(43) Pub. Date: Mar. 23, 2006

(54) Communication device with image transmission operation and method thereof

(76) Inventor: Andrew E. Ray, Champaign, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/945,185

(22) Filed: Sep. 20, 2004

(51) Int. Cl. H04N 5/232

(52) U.S. Cl. 348/211.2; 348/14.02

(57) ABSTRACT

A communication device (100, 200) is adapted to participate in a primary communication on a communication channel with at least one other communication device (250); and simultaneously transmit an image to the at least one other communication device (250) or and alternative communication device using the communication channel or an alternative communication channel.

### BACKGROUND OF THE INVENTION

1. Field of the Invention

The present invention is generally related to communication devices; and in particular to communication devices with imaging capability.

2. Description of the Related Art

Historically, communication devices, (such as cellular telephones, two way messaging devices, wired telephones, mobile devices, personal computers, personal digital assistants (PDA), and other devices with communication operation) have had the ability to receive and/or transmit data and/or voice messages sent from a communication system, and perform standard functions in response to message receipt such as storing the message, displaying the message, or alerting the user of receipt of the message. Data messages can include a numeric message such as a phone number, or an alphanumeric message containing one unique piece of information such as “meeting in my office at 6:00 pm.” Voice communication can include traditional two way calling using devices operating on compatible communication protocols.

The user is alerted of receipt of a new message or an incoming voice call by an audible alert or a vibratory alert. The display of many communication devices includes a message indicator for each message it has received and stored in memory. This message indicator allows a quick view for the user of how many messages are in the communication device and also allows the user to quickly pick a message to view. The display further can include a call receipt message indicating to the user a new voice or data call is being received and/or the source of the new incoming communication.

As communication devices continue to evolve, device capabilities continue to expand. One such capability is connectivity to imaging devices such as still-imaging and video cameras. For example, there are still-image and video camera accessories that can be connected to a cellular telephone. Some devices further provide capability to receive images such as photographs taken by other electronic devices such as a cellular telephone receiving a photograph from a personal computer. Further, some device manufacturers are offering communication devices with built-in imaging devices including still image and/or video cameras. Once the images are stored on the communication device, the device user can view them on the display and utilize the images in other available applications such as backgrounds, standby screens, contact lists, and the like.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 illustrates a communication device.

FIG. 2 is an exemplary block diagram of the communication device of FIG. 1.

FIG. 3 illustrates an exemplary embodiment of a contact directory stored within the communication device of FIGS. 1 and 2.

FIG. 4 illustrates an exemplary embodiment of a contact preferences directory stored within the communication device of FIGS. 1 and 2.

FIGS. 5 and 6 are flowcharts illustrating an exemplary embodiment of the operation of the communication device of FIGS. 1 and 2.

### DETAILED DESCRIPTION

The present invention relates to a communication device and method of operation therefore which provides the ability to transmit images (i.e. still images and/or video clips) via multimedia messaging to an address determined by the context of the situation. The present invention provides a device user the capability to input an image (for example, take a picture) and transmit the image immediately to the same destination as a currently active call. This invention ties together the imaging functionality and messaging with automatic address in a novel manner.

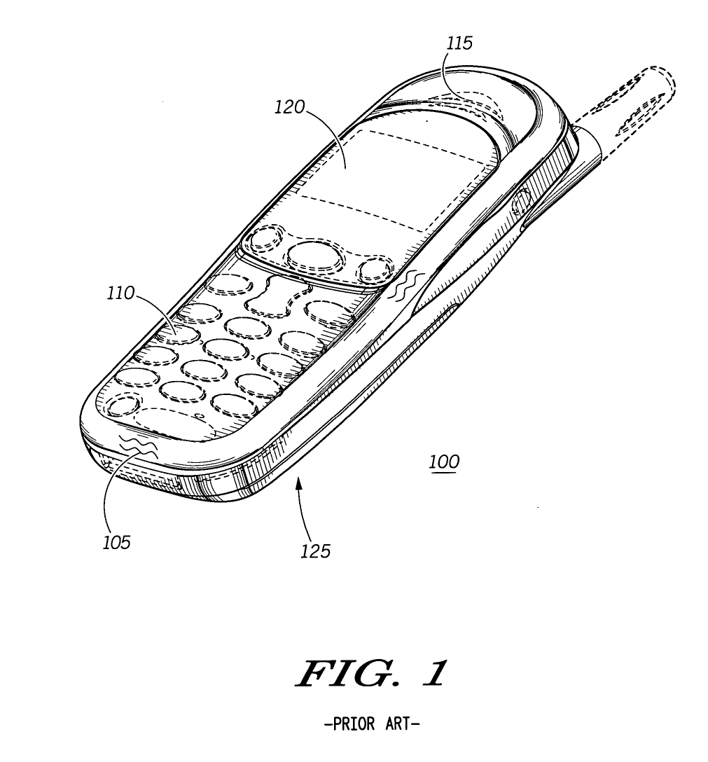

Referring to FIG. 1, a communication device 100 is illustrated. The communication device 100, for example, can be a cellular telephone (as illustrated), a cordless telephone, a wired landline telephone, a personal communicator, or an equivalent. Similarly, the communication device 100 can be a PDA (personal digital assistant), a portable personal computer, or an equivalent. In the following description, the term “communication device” refers to any of the devices mentioned above or an equivalent device with communication capability.

The communication device 100 preferably includes a user interface (such as a microphone 105, a keypad 110, an earpiece 115, a display 120, and a housing 125). The microphone 105, for example, converts an acoustic input signal received from a voice transmission to the communication device 100 into an electric input signal. The earpiece 115 can convert an electric output signal into an acoustic output signal transmitted from the communication device 100 to be heard by the listener of the communication device 100. The keypad 110 allows the user of the communication device 100 to enter data such as phone numbers and text memos and to perform various functions within the communication device 100. The display 120 displays data such as one or more communication messages, phone numbers, and caller identifications. The display 120 further can display graphics such as screen savers, wallpaper, gaming applications, and the like. Similarly, the display 120 can display still image and video images received by the communication device, programmed into the communication device 100, or captured by the communication device 100 itself. The housing 125 encloses the various elements of the communication device 100 and provides mechanical support for the device.

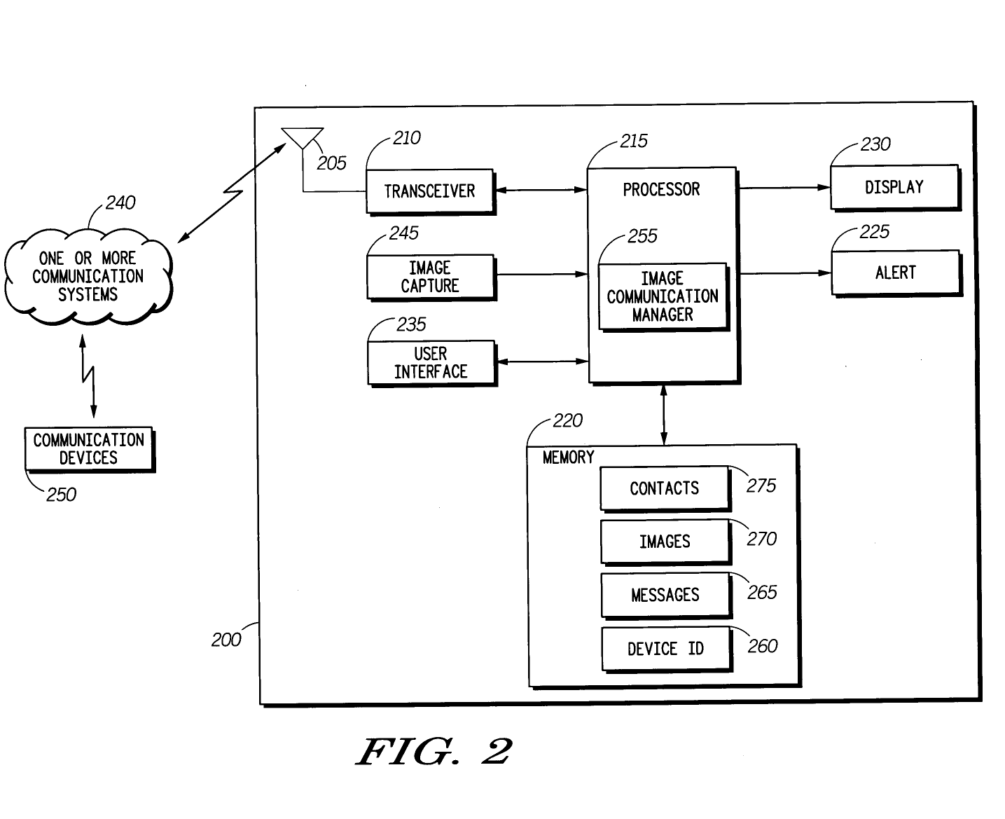

FIG. 2 is an electronic block diagram of one embodiment of the communication device 100 of FIG. 1. Specifically, FIG. 2 illustrates a communication device 200 for use with the present invention. The communication device 200, by way of example only, can be embodied in a cellular radiotelephone having a conventional cellular radio transceiver circuitry, as is known in the art, and will not be presented here for simplicity. The invention is alternatively applied to other communication devices such as, for example, messaging devices, personal digital assistants and personal computers with communication capability, mobile radio handsets, cordless radiotelephone and the like. It will be appreciated by those of ordinary skill in the art that the communication device 200 is illustrative of one embodiment for use with the present invention, and further alternative embodiments such as fixed network devices or cable broadcast devices can be used in accordance with the present invention.

As illustrated, the communication device 200 includes an antenna 205, a transceiver 210, a processor 215, a memory 220, an alert 225, a display 230, a user interface 235, and an image capture means 245. The antenna 205 intercepts transmitted signals such as a message, data, or a voice call from one or more communication devices 250 via one or more communication systems 240 and transmits signals to the one or more communication devices 250 via the one or more communication systems 240. It will be appreciated by those of ordinary skill in the art that one or more of the communication systems 240, in accordance with the present invention, can function utilizing any wireless radio frequency (RF) channel, for example, a two-way messaging channel, a mobile cellular telephone channel, or a mobile radio channel. Similarly, it will be appreciated by one of ordinary skill in the art that one or more of the communication systems 240 can function utilizing other types of wireless communication channels such as infrared channels and/or Bluetooth channels. Similarly, it will be appreciated by one of ordinary skill in the art that one or more of the communication systems 240 can function utilizing a wireline communication channel such as a local area network (LAN) or a wide area network (WAN) or a combination of both. The LAN, for example, can employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. The WAN, for example, can use a physical network media such as X.25, Frame Relay, ISDN, Modem dial-up or other media. In the following description, the term “communication system” refers to any of the communication systems mentioned above or an equivalent. Further, in the following description, the term “communication device” refers to any device operating within the communication systems mentioned herein or an equivalent.

The antenna 205 is coupled to the transceiver 210, which employs conventional demodulation techniques for receiving the communication signals. The transceiver 210 is coupled to the processor 215 and is responsive to commands from the processor 215. When the transceiver 210 receives a command from the processor 215, the transceiver 210 sends a signal via the antenna 205 to one or more of the communication systems 240. In an alternative embodiment (not shown), the communication device 200 includes a receive antenna and a receiver for receiving signals from one or more of the communication systems and a transmit antenna and a transmitter for transmitting signals to one or more of the communication systems. It will be appreciated by one of ordinary skill in the art that other similar electronic block diagrams of the same or alternate type can be utilized for the communication device 200.

Coupled to the transceiver 210, is the processor 215 utilizing conventional signal-processing techniques for processing received messages. It will be appreciated by one of ordinary skill in the art that additional processors can be utilized as required to handle the processing requirements of the processor 215. The processor 215 decodes an identification in the demodulated data of a received message or call, compares the decoded identification with one or more identifications 260 stored in the memory 220, and when a match is detected, proceeds to process the remaining portion of the received message or call. The one or more identifications 260, for example, can be a unique selective call address assigned within a wireless communication system, an electronic mail address, an IP (internet protocol) address or any other similar identification.

In accordance with the present invention, the processor 215 includes an image communication manager 255 for managing communication of stored images to the one or more communication devices 250. It will be appreciated by those of ordinary skill in the art that the image communication manager 255 can be hard coded or programmed into the communication device 200 during manufacturing, can be programmed over-the-air upon customer subscription, or can be a downloadable application. It will be appreciated that other programming methods can be utilized for programming the image communication manager 255 into the communication device 200. It will be further appreciated by one of ordinary skill in the art that the image communication manager 255 can be hardware circuitry within the communication device 200. In accordance with the present invention, the image communication manager 255 can be contained within the processor 215 as illustrated, or alternatively can be an individual block operatively coupled to the processor 215 (not shown).

To perform the necessary functions of the communication device 200, the processor 215 is coupled to the memory 220, which preferably includes a random access memory (RAM), a read-only memory (ROM), an electrically erasable programmable read-only memory (EEPROM), and flash memory. The memory 220, for example, includes memory locations for the storage of one or more received or transmitted messages 265, one or more image data 270, one or more contact directories 275, one or more software applications, and the like. The flash memory is especially useful for easy and fast information storage of the images taken by the image capture means 245 such as an integrated camera function.

It will be appreciated by those of ordinary skill in the art that the memory 220 can be integrated within the communication device 200, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 200. The SIM card can be used to transfer a variety of information from/to the communication device 200 and/or any other compatible device. The external memory can be, for example, a removable memory such as SD/MMC, TriFlash-R, or TransFlash. The memory 220 preferably stores one or more images 260 and one or more associated image orientation data 265.

Upon receipt and processing of a message or a call, the processor 215 preferably generates a command signal to the alert 225 as a notification that the message has been received and stored or alternatively that a call is waiting for a response. The alert 225 similarly can be utilized for other alerting notifications such as an alarm clock, expiration of a timer, or the memory 220 being at its memory storage limitations. Similarly, the alert 225 can be utilized for alerting a user of a request for a user input. The alert 225 can include a speaker (not shown) with associated speaker drive circuitry capable of playing melodies and other audible alerts, a vibrator (not shown) with associated vibrator drive circuitry capable of producing a physical vibration, or one or more light emitting diodes (LEDs) (not shown) with associated LED drive circuitry capable of producing a visual alert. It will be appreciated by one of ordinary skill in the art that other similar alerting means as well as any combination of the audible, vibratory, and visual alert outputs herein described can be used for the alert 225.

Upon receipt and processing of a message or a received call, the processor 215 preferably also generates a command signal to the display 230 to generate a visual notification. Similarly, the display 230 can be utilized as a means for providing a visual image to the user. For example, one or more still images or video images can be displayed on the display 230 for viewing by the user.

Preferably, the user interface 235 is coupled to the processor 215. The user interface 235 can include a keypad such as one or more buttons used to generate a button press or a series of button presses. The user interface 235 can also include a voice response system or other similar method of receiving a manual input initiated by the device user. The processor 215, in response to receiving a user input via the user interface 235 performs commands as required. For example, the user interface 235 can be utilized for performing functions related to the messages stored in the memory 220 such as reading, replying, or deleting one or more stored email messages. The user interface 235 further can be used to perform various functions and make various operational choices for functioning of the communication device 200. For example, the user interface 235 can be used to provide inputs to the image communication manager 255 for image capture by the imaging capture means 245 and transmission of various images via the transceiver 210 to one or more communication devices 250 via the one or more communication systems 240.

The communication device 200, as illustrated, includes the image capture means 245 coupled to the processor 215. It will be appreciated by one of ordinary skill in the art that the image capture means 245 can be integrated within the communication device 200 or alternatively externally coupled to the communication device 200. The image capture means 245, for example, can be a camera including the necessary circuitry for providing camera functionality to the communication device 200. Preferably, the image capture means 245 includes functionality of a digital camera. For example, the image capture means 245 can include software and circuitry for the calculations that are made each time a picture is taken. The image capture means 245 provides functionality to preview, capture, compress, filter, store, transfer, and display the image. Typically, the image capture means 245 includes a microprocessor programmed to perform these calculations and other various functions.

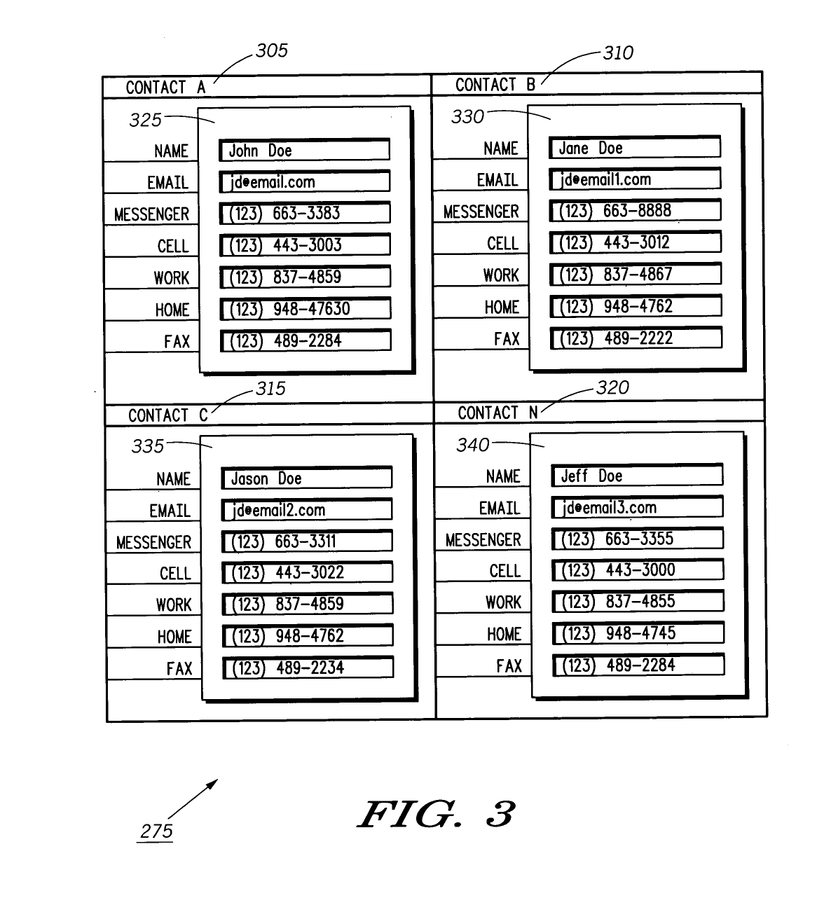

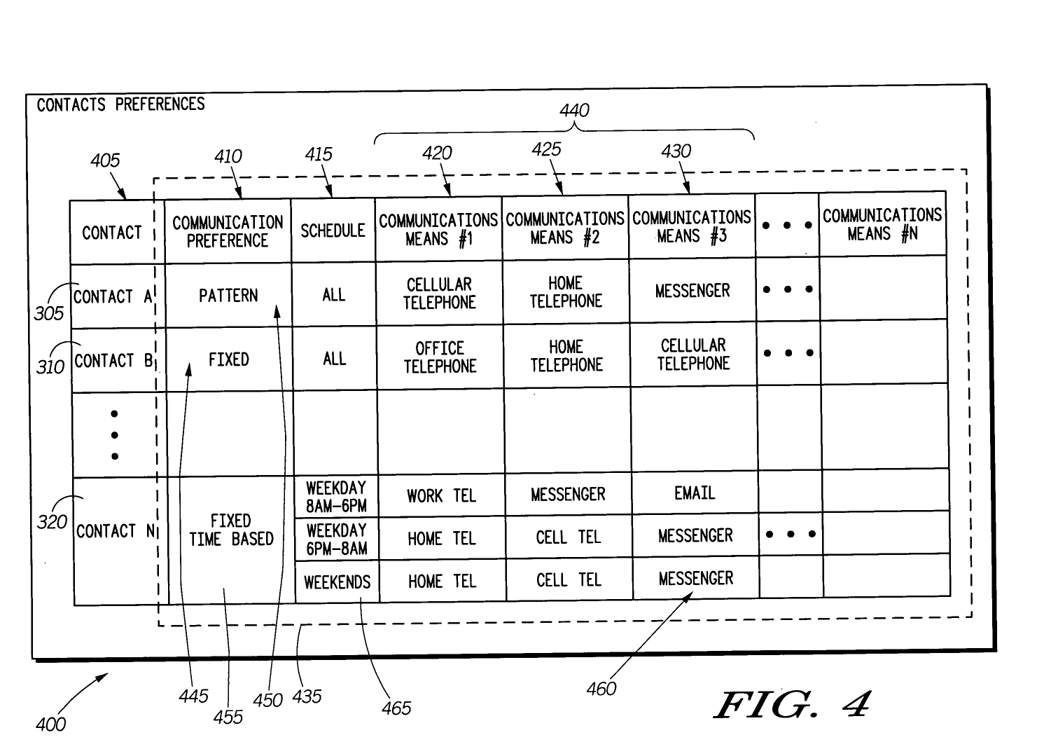

FIGS. 3 and 4 are exemplary illustrations of information stored within the memory 220 of the communication device 200. Specifically FIG. 3 illustrates an exemplary embodiment of the contact directory 275 and FIG. 4 illustrates an exemplary embodiment of a contact preferences directory 400.

Referring to FIG. 3, as illustrated, the contact directory 275 includes one or more contacts (305, 310, 315, 320) along with one or more communication means (325, 330, 335, 340) for each of the one or more contacts (305, 310, 315, 320) respectively. The one or more communication means (325, 330, 335, 340) can include, for example, one or more email addresses, one or more telephone numbers, one or more facsimile numbers, one or more messaging addresses and the like.

Referring to FIG. 4, the contact preferences directory 400 preferably stores one or more contacts 405 along with one or more communication preference information 435 associated with each of the one or more contacts. The communication preference information 435 preferably includes a communication preference 410, a schedule 415, a communication means order 440 such as a first communication means 420, a second communication means 425, a third communication means 430, and the like. It will be appreciated by those of ordinary skill in the art that although three communication means are illustrated, any number of communication means can be included. Further, it will be appreciated by those of ordinary skill in the art that additional communication means can be added and current communication means can be deleted by the device user either manually via the user interface 135 or via a received signal.

The communication preference 410, for example, can be a fixed communication order 445, a pattern communication order 450, a fixed time based communication order 455, and the like. The schedule 415 indicates when the communication preference 410 will be utilized for communicating with the particular contact 405. For example, the schedule 415 can identify using the communication preference 410 for a fixed communication order 445 or a pattern communication order 450. Alternatively, the schedule 415 can identify one or more time periods 465 for an associated time based communication order for each of the time periods. Those skilled in the art will recognize that the information stored within the contact preferences directory 400 can be entered manually by the device of the communication device 200 user via the user interface 235, can be programmed into the communication device 200 either via signals received by the antenna 205 or direct contact programming methods, or any other equivalent method.

To exemplify the manner in which information is stored within the contact preferences directory 400, FIG. 4 illustrates the communication preference information 435 for contact A (305), contact B (310) through contact N (325). As illustrated, the pattern communication order 450 is stored for the communication preference 410 for contact A (305) for the schedule 415 of all periods of time. The pattern communication order 450 at the current time illustrated provides for the first communication means 420 to be contact A's cellular telephone, the second communication means 425 to be contact A's home telephone, and the third communication means 430 to be contact A's messenger.

As illustrated in FIG. 4, for contact B (310), the fixed communication order 445 has been stored for the communication preference 410 for the schedule 415 of all periods of time. The fixed communication order 445 illustrated provides for the first communication means 420 to be contact B's office telephone, the second communication means 425 to be contact B's home telephone, and the third communication means 430 to be contact B's cellular telephone.

As illustrated in FIG. 4, for contact N (320), the fixed time based communication order 455 has been stored for the communication preference 410 for the schedule 415 including three time periods (weekdays 8 AM to 6 PM, weekdays 6 PM to 8 AM, and weekends). The fixed time based communication order 455 during weekdays 8 AM to 6 PM illustrated provides for the first communication means 420 to be contact N's work telephone, the second communication means 425 to be contact N's messenger, and the third communication means 430 to be contact N's email.

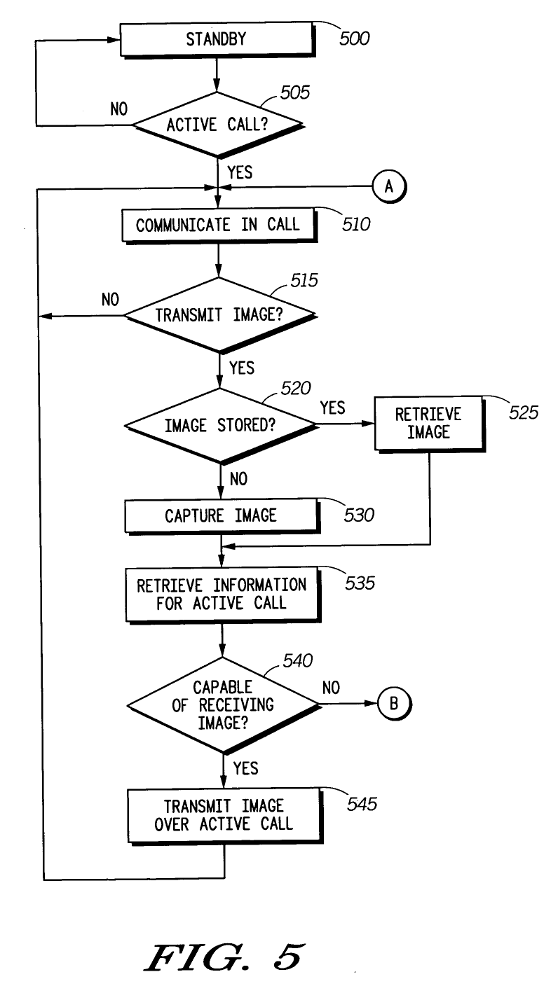

FIG. 5 is a flowchart illustrating one embodiment of the operation of the communication device (100, 200) of FIGS. 1 and 2. The operation of FIG. 5, for example, can be programmed into the image communication manager 255. As illustrated, the operation begins with Step 500 in which the communication device (100, 200) is in standby mode. Standby mode provides low power operation for the communication device (100, 200). Next in Step 505, the operation determines whether or not the communication device (100, 200) is in an active call. For example, the device user of the communication device (100, 200) can be active in a cellular telephone call with another user of another communication device 250 via one of the communication systems 240. It will be appreciated by those of ordinary skill in the art that an active call includes any communicative coupling of the communication device with at least one other communication device within a communication channel. The active call further includes participating in a primary communication on the communication channel. When an active call is not detected in Step 505, the operation returns to the standby operation of Step 500.

When an active call is detected in Step 505, the operation continues to node A and Step 510 in which the device user participates within the active call. Next, in Step 515, the operation determines whether the device user desires to transmit an image to at least one other participant within the active call. For example, the device user can indicate a desire to transmit an image using the user interface 235. When no image is desired to be transmitted in Step 515, the operation cycles back to node A and Step 510 and the active call continues. When the device user indicates a desire to transmit an image in Step 515, (for example, the image communication manager 255 receives an input from the user interface 235 indicating such), the operation continues to Step 520 in which the operation determines whether the image to be transmitted is stored in the memory 220. For example, the image communication manager 255 can query the images 270 stored in the memory 220 to determine whether or not the desired image is stored. Further, the device user can indicate that the image to be transmitted is stored in the memory 220 via the user interface 235. When the image is a stored image in Step 520, the operation continues to Step 525 in which the image is retrieved. When the image is not a stored image in Step 520, the operation continues to Step 530 in which the image is captured using the image capture means 245.

After the image is retrieved in Step 525 or the image is captured in Step 530, the operation continues to Step 535 in which the communication information for the active call is retrieved. The communication information typically includes the other communication devices' identifications and/or available capabilities, the communication channel identification and/or communication protocol. Next, in Step 540, the operation determines whether or not the communication device being used in the active call by the other participant (s) is (are) capable of receiving an image. When the participant's device is capable of receiving images in Step 540, the operation continues to Step 545 in which the image is transmitted over the active call to the participant's device. Generally, Step 545 comprises transmitting the image from the communication device to at least one other communication device using the communication channel in which the two devices are simultaneously participating in a primary communication. The operation then cycles back to node A and Step 510 as the active call continues.

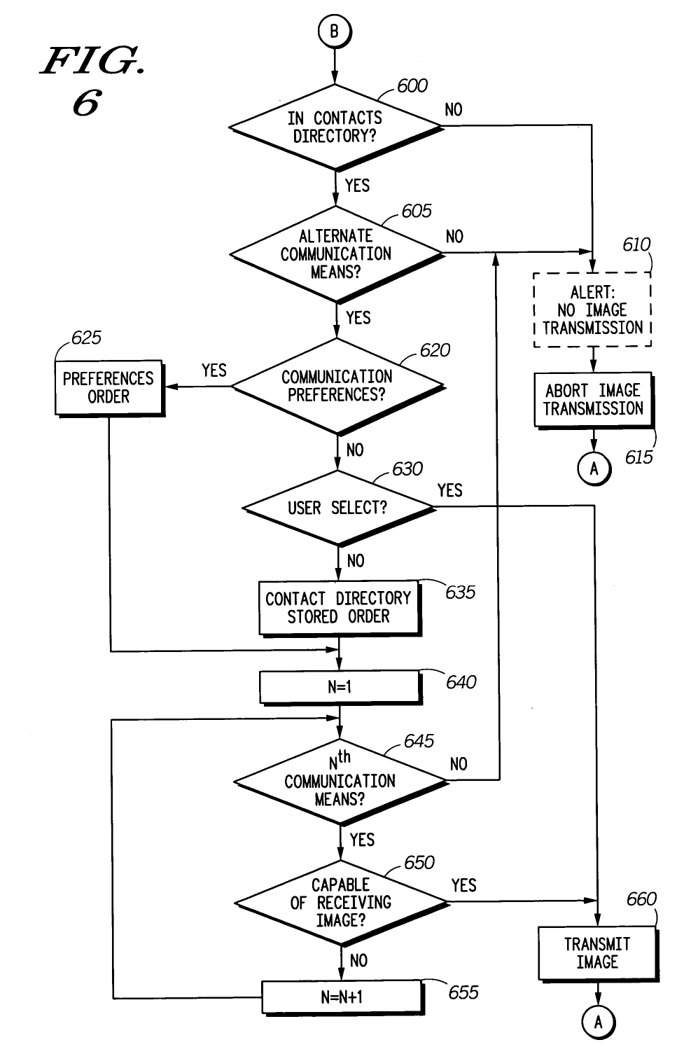

When the participant's device is not capable of receiving an image, the operation continues at node B as will be illustrated and described in further detail in FIG. 6. After node B of FIG. 6, the operation continues with Step 600 in which the operation determines whether or not the participant of the active call to whom the image is desired to be transmitted is stored within the contacts directory 275. For example, the image communication manager 255 can query the contacts directory 275 within the memory 220 for the active call participant. When the participant is stored in the contacts directory 275 in Step 600, the operation continues with Step 605 in which the operation determines whether or not the participant has one or more alternate communication means. For example, the image communication manager 255 can query the contacts directory 275 for alternate communication means for the active call participant. When no alternate communication means are available in Step 605 and/or when the participant is not stored in the contacts directory 275, the operation optionally continues with Step 610 in which an alert is generated within the communication device (100, 200) indicating that the image will not be transmitted. For example, the image communication manager 255 can cause an audible alert via the alert 225 and/or can cause an indication to be displayed on the display 230. Next, in Step 615, the image transmission operation is aborted. The operation then continues to Node A of FIG. 5 and the active call continues.

When an alternate communication means is available in Step 605, the operation continues to Step 620 in which it is determined whether or not communication preferences have been set for the participant. For example, the image communication manager 255 can query the contacts preferences directory 400 for communication preferences for the participant. When preferences are available in Step 620, the operation continues to Step 625 in which the preferences order is set for further processing. When preferences are not stored for the participant, the operation continues to Step 630 in which it is determined whether or not a user selection has been set. For example, the device user can select the alternate communication means for transmission of the image via the user interface 235. When the selects an alternate communication means for transmitting the image, the image is transmitted to the user selection in Step 660. (note: It is presumed that the user selection is capable of receiving an image as illustrated in FIG. 6. In an alternative operation, when the user selection is not capable of receiving an image (not shown) the operation can cycle back to optional Step 610.) The operation then cycles back to node A of FIG. 5 as the active call continues. When no user selection is detected, the operation continues with Step 635 in which the contact directory stored order is selected for further processing.

Next, and after Step 625, the operation continues with Step 640 in which a counter is set to N=1. Next, in Step 645, the operation determines whether or not an Nth communication means for the participant exists. When there is no Nth communication means for the participant, the operation cycles back to the optional Step 610 as described previously herein.

When an Nth communication means exists in Step 645, the operation continues to Step 650 in which it is determined whether or not the Nth communication means is capable of receiving an image. When the Nth image is not capable of receiving an image, the counter is incremented to N=N+1 in Step 655. The operation then cycles back to Step 645. When the Nth communication means is capable of receiving messages, the image is transmitted to the Nth communication means in Step 660. The operation then cycles back to node A of FIG. 5 as the active call continues.

It will be appreciated by those of ordinary skill in the art that the operation of FIG. 6 can alternatively take place within the communication system 240 in which the communication device (100, 200) operates. For example, the contact directory, contact communication preferences, and the like can be stored within a server of the communication system 240 and the selection operation in FIG. 6 can be accomplished within the server in response to a request from the communication device (100, 200).

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

We claim:

1. A method within a communication device of transmitting images comprising the steps of:
communicatively coupling the communication device to at least one other communication device within a communication channel;
participating in a primary communication on the communication channel by the communication device and the at least one other communication device; and
simultaneously transmitting an image from the communication device to the at least one other communication device using the communication channel.

2. The method as recited in claim 1 wherein the communicatively coupling step comprises activating a communication call between the communication device and the at least one other communication device.

3. The method as recited in claim 1 further comprising prior to the transmitting step:
detecting an image transmission request from a device user.

4. The method as recited in claim 1, wherein the image is stored within a memory of the communication device, the method further comprising prior to the transmission step:
retrieving the image from the memory.

5. The method as recited in claim 1, further comprising prior to the transmission step:
capturing the image using an image capture means coupled to the communication device.

6. The method as recited in claim 1, further comprising prior to the transmission step:
identifying the at least one other communication device; and
identifying the communication channel.

7. The method as recited in claim 1, further comprising prior to the transmission step:
confirming the at least one other communication device is capable of receiving an image.

8. A method within a communication device of transmitting images comprising the steps of:
communicatively coupling the communication device to at least one other communication device within a communication channel;
participating in a primary communication on the communication channel by the communication device and the at least one other communication device;
identifying an alternate communication means for a device user of the at least one other communication device, wherein the alternate communication means comprises an alternate communication device operating within an alternate communication channel; and
transmitting an image from the communication device to the alternate communication device using the alternate communication channel.

9. The method of claim 8, further comprising prior to the identifying step:
determining that the at least one other communication device is not capable of receiving an image.

10. The method of claim 8, wherein the alternate communication means is identified within a contacts directory stored within the communication device.

11. The method of claim 8, wherein the alternate communication means is identified within a contacts directory stored within a communication network in which the communication channel operates.

12. The method of claim 8, further comprising prior to the identifying step:
associating the at least one other communication device with a plurality of alternate communication means,
wherein the identifying step comprises:
using a communication preference to identify the alternate communication means from the plurality of alternate communication means.

13. The method of claim 12, wherein the communication preference is stored within the communication device.

14. The method of claim 12, wherein the communication preference is stored within a communication network in which the communication channel operates.

15. The method of claim 8, further comprising prior to the identifying step:
associating the at least one other communication device with a plurality of alternate communication means,
wherein the identifying step comprises:
receiving a user input within the communication device identifying the alternate communication means from the plurality of alternate communication means.

16. The method of claim 8, further comprising prior to the identifying step:
associating the at least one other communication device with a plurality of alternate communication means,
wherein the identifying step comprises:
determining an alternate communication means capable of receiving an image from the plurality of alternate communication means.

17. The method of claim 16, wherein the determining step operates within the communication device.

18. The method of claim 16, wherein the determining step operates within a communication network in which the communication channel operates.

19. The method as recited in claim 8 wherein the communicatively coupling step comprises activating a communication call between the communication device and the at least one other communication device.

20. The method as recited in claim 8, further comprising prior to the transmitting step:
detecting an image transmission request from a user of the communication device.

21. The method as recited in claim 8, wherein the image is stored within a memory of the communication device, the method further comprising prior to the transmission step:
retrieving the image from the memory.

22. The method as recited in claim 8, further comprising prior to the transmission step:
capturing the image using an image capture means coupled to the communication device.

23. The method as recited in claim 8, further comprising prior to the transmission step:
confirming the alternate communication device is capable of receiving an image.

24. A method within a communication device of transmitting images comprising the steps of:
communicatively coupling the communication device to at least one other communication device within a first communication channel;
participating in a primary communication on the first communication channel by the communication device and the at least one other communication device; and
simultaneously transmitting an image from the communication device to the at least one other communication device using a second communication channel.

25. The method as recited in claim 24, wherein the communicatively coupling step comprises activating a communication call between the communication device and the at least one other communication device.

26. The method as recited in claim 24, further comprising prior to the transmitting step:
detecting an image transmission request from a device user.

27. The method as recited in claim 24, wherein the image is stored within a memory of the communication device, the method further comprising prior to the transmission step:
retrieving the image from the memory.

28. The method as recited in claim 24, further comprising prior to the transmission step:
capturing the image using an image capture means coupled to the communication device.

29. The method as recited in claim 24, further comprising prior to the transmission step:
identifying the at least one other communication device; and
identifying the second communication channel.

30. The method as recited in claim 24, further comprising prior to the transmission step:
confirming the at least one other communication device is capable of receiving an image.

31. A communication device comprising:
a transceiver adapted to:
communicatively couple the communication device to at least one other communication device within a communication channel;
participate in a primary communication on the communication channel with the at least one other communication device; and
simultaneously transmit an image to the at least one other communication device using the communication channel.

32. The communication device as recited in claim 24, further comprising:
an image capture means for capturing the image to be transmitted.

33. A communication device comprising:
a transceiver adapted to:
communicatively couple the communication device to at least one other communication device within a first communication channel;
participate in a primary communication on the first communication channel with the at least one other communication device; and
simultaneously transmit an image to the at least one other communication device using a second communication channel.

34. The communication device as recited in claim 33, further comprising:
an image capture means for capturing the image to be transmitted.
